(19) United States
(12) Patent Application Publication
(10) Pub. No.: US 2025/0342392 A1
(43) Pub. Date: Nov. 6, 2025

(54) COMMUNITY-BASED FEDERATED TRAINING USING LEADER NODES

(71) Applicant: Dell Products L.P., Round Rock, TX (US)

(72) Inventors: Italo Gomes Santana, Rio de Janeiro (BR); Thais Luca Marques de Almeida, São Gonçalo (BR); Diego Vrague Noble, Pelotas (BR); David Burth Kurka, Campinas (BR); Karen Braga Enes, Belo Horizonte (BR)

(73) Assignee: Dell Products L.P., Round Rock, TX (US)

(21) Appl. No.: 18/653,743

(22) Filed: May 2, 2024

(51) Int. Cl. G06N 20/00

(52) U.S. Cl. CPC G06N 20/00

(57) ABSTRACT

Techniques are disclosed for community-based federated training by leader node representation. An example system includes a memory having instructions, and a processor communicatively coupled to the memory and configured to execute the instructions. The instructions can include: using a community detection (CD) algorithm to partition a network of nodes into a plurality of communities; using graph-based measurements of the network to elect a leader node for each community; and performing federated learning within and between the communities through the elected leader nodes.

### FIELD

Example embodiments generally relate to machine learning (ML) in distributed network environments. More specifically, at least some embodiments relate to systems, hardware, software, computer-readable media, and methods for federated learning (FL), a collaborative machine learning approach where a shared model is trained across multiple decentralized devices or servers holding local data samples.

### BACKGROUND

Conventional federated learning involves a central server that aggregates model updates from client nodes. Decentralized federated learning emerged as an alternative to address limitations of the central server, allowing nodes to update their models based on information from adjacent nodes. Community detection algorithms are also relevant in this field, since they partition networks into communities based on similarity measures, which can be leveraged for various network optimization tasks.

### SUMMARY

Techniques are disclosed for community-based federated training by leader node representation.

In one embodiment, a system includes a memory having instructions, and a processor communicatively coupled to the memory and configured to execute the instructions. The instructions can include: using a community detection (CD) algorithm to partition a network of nodes into a plurality of communities; using graph-based measurements of the network to elect a leader node for each community; and performing federated learning within and between the communities through the elected leader nodes.

In some embodiments, performing federated learning within the communities includes: receiving model updates from client nodes within each community; aggregating the received model updates at the leader node of each community; and broadcasting the aggregated model from the leader node to the client nodes within the same community. The federated learning between the communities can be performed exclusively through the leader nodes, thereby reducing overall communication over the nodes of the network. Performing federated learning between the communities can include: exchanging aggregated models between the leader nodes of different communities; and updating the aggregated models based on the exchanged models. The leader node can be elected using a centrality measure to determine a representative node within each community. The representative node can be a most representative node within the community. The centrality measure can be betweenness centrality. The system can be operable in a synchronous exchange regime or an asynchronous exchange regime for model exchanges among communities. In the synchronous exchange regime, each leader node can receive models from other leader nodes and aggregate the received models into a single model for distribution to client nodes within its community. In the asynchronous exchange regime, each leader node can aggregate models based on a predefined number of received models without waiting for all models from other leader nodes. The instructions can further include determining a number of communities k into which the network is to be partitioned, wherein k is user-defined or automatically estimated by the CD algorithm. The CD algorithm can be selected from a group comprising a Girvan-Newman algorithm, non-negative matrix factorization methods, and hierarchical clustering methods. The system can be operable in a smart farming environment so as to enhance agricultural processes by reducing network usage and enabling effective operation despite geographical dispersion of devices. The network can be represented as an undirected graph G=(V,E), V is a set of vertices representing the nodes, and E is a set of edges representing connections between the nodes. The graph G can be an in-memory graph.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

### In the Drawings:

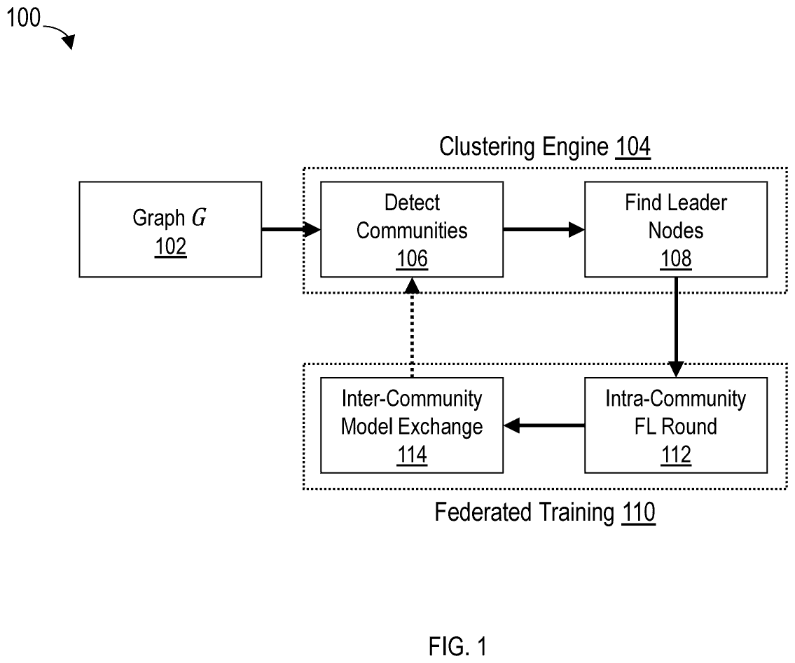

FIG. 1 discloses aspects of an example network system, in accordance with illustrative embodiments.

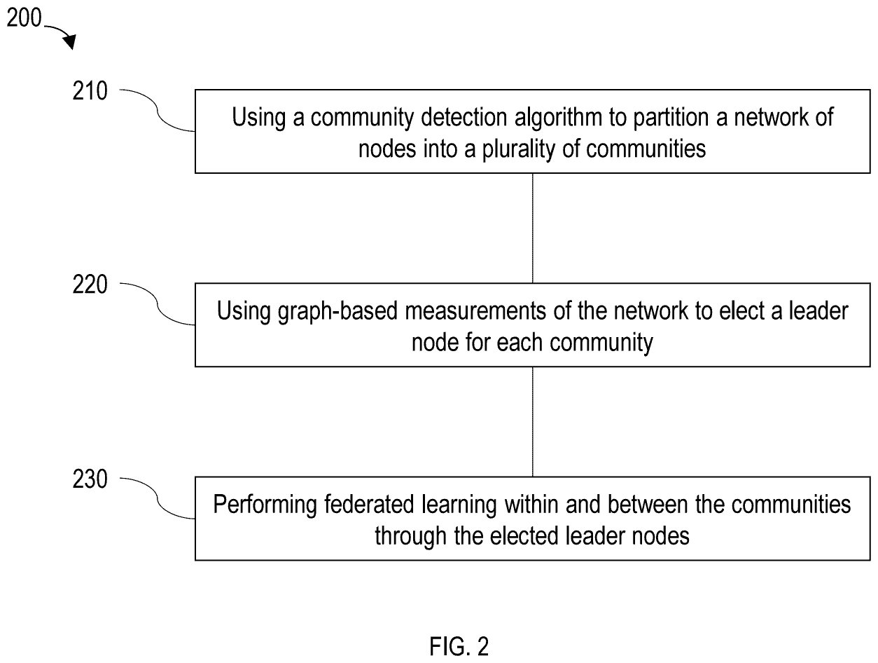

FIG. 2 discloses a flowchart of an example method, in accordance with illustrative embodiments.

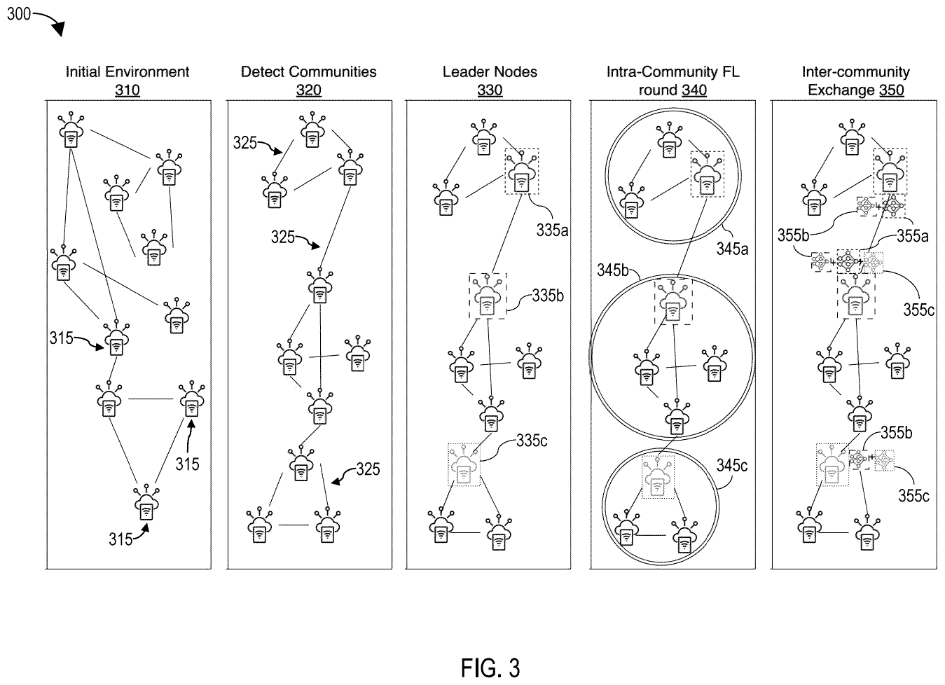

FIG. 3 discloses aspects of an example environment, in accordance with illustrative embodiments.

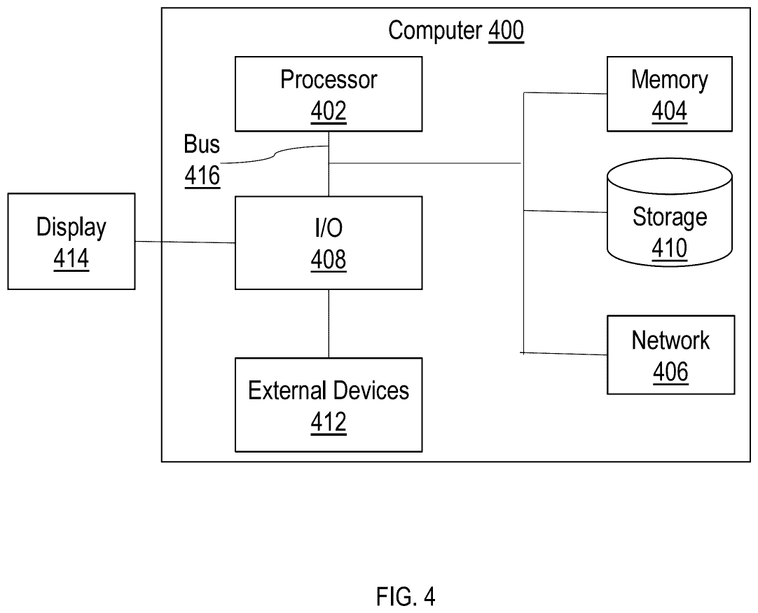

FIG. 4 discloses aspects of a computing entity configured and operable to perform any of the disclosed methods, processes, and operations, in accordance with illustrative embodiments.

### DETAILED DESCRIPTION

Example embodiments generally relate to machine learning (ML) in distributed network environments. More specifically, at least some embodiments relate to systems, hardware, software, computer-readable media, and methods for federated learning (FL), a collaborative machine learning approach where a shared model is trained across multiple decentralized devices or servers holding local data samples.

Disclosed herein are techniques for federated training based on communities using leader nodes. In one implementation, the network solution discussed herein leverages community detection (CD) techniques to partition a network into communities and elects leader nodes based on graph-based measurements, such as betweenness centrality. The leader nodes are configured for aggregating models within their community and facilitating inter-community model exchanges, thereby reducing communication overhead and computational burden.

Example embodiments of the disclosed system include a network of nodes, a clustering engine, and leader nodes associated with the communities. The clustering engine is configured to use a CD algorithm to partition the network, and the leader nodes are configured to aggregate and communicate models. The present system is operable in both synchronous and asynchronous exchange regimes, allowing for flexibility in model exchanges among communities.

Example embodiments of the disclosed method involve partitioning the network into communities, electing leader nodes, and performing federated learning within and between these communities through the elected leaders. The present methods can be applied in various settings, including smart farming environments, where the disclosed techniques optimize agricultural processes by reducing network usage and enabling effective operation despite geographical dispersion of devices.

Advantageously, use of CD algorithms and graph-based measurements helps reduce communication costs and improve network representation in decentralized federated learning (DFL) settings. Particularly, the disclosed approach incorporates leader election and considers inter-community relationships for model training.

Generally, the disclosed techniques provide a technical solution to the challenges of DFL by introducing a community-based approach that enhances communication efficiency and model training effectiveness in distributed networks.

In the realm of distributed machine learning, federated learning has been a significant step forward in enabling collaborative model training while maintaining data privacy. A canonical form of FL involves a central node that aggregates updates from client nodes to form a global model. However, this centralized approach can lead to bottlenecks, as the central node becomes a single point of failure and communication overhead can be substantial, especially with a large number of nodes.

Decentralized FL addresses some of these issues by allowing model updates without a central node, reducing network usage and mitigating communication bottlenecks. However, DFL can still suffer from inefficiencies due to the large number of potential connections and the computational expense of selecting optimal representative nodes for communication.

Conventional approaches to improving DFL have included clustering based on data characteristics and training independent models without a leader election process. These conventional methods, while useful, do not fully address the communication overhead and lack a mechanism for efficient inter-community model training.

Federated learning refers to a form of collaborative learning that ensures privacy over data distributed on large networks. In its canonical form, a Machine Learning model is trained collaboratively on multiple nodes that use a central node that receives updates from client nodes and aggregates these updates to create a global model. Decentralized federated learning arose as an alternative to centralized federated learning (CFL) architectures in such a way that the model parameters are updated without utilizing a central node as in CFL. The participants of a DFL architecture will generally contain a ML model that is updated according to its adjacent nodes, significantly mitigating the network usage and avoiding communication bottlenecks involving a single central node. Even in DFL architectures, bottlenecks in communication can still occur since the total number of nodes and mutual connections can be substantially large.

One way of mitigating these communication overheads is by selecting representative nodes to deal with these transmissions. However, an optimal selection can be computationally expensive since this is an optimization problem intractable in polynomial time, belonging to the NP-hard class of optimization problems. Additionally, these selected nodes may not be adequate as representatives for the entire network.

The disclosed techniques present an improved approach that uses Community Detection techniques to find these nodes and keep sufficient network representation.

The following are example technical problems addressed by the present systems and methods:
partitioning nodes into clusters is an open problem in which many methods can be applied, and no method has proven to be most suitable in many FL scenarios;
determining the number of clusters that a particular set of nodes should be split into is also an issue in many FL scenarios; and
selecting representative and reliable nodes (such as the most representative and reliable nodes) to improve network communication by reducing communication costs.

The present systems and methods provide technical solutions to these technical problems by offering new propositions on mitigating the computational burden of training ML models in FL settings. Particularly, the disclosed network system is generally configured to combine CD techniques to improve on DFL.

Advantageously, the disclosed techniques leverage the capability to select representative nodes of each set of nodes (such as the most representative nodes) by leveraging CD algorithms and graph-based measurements. Using the present configuration, communication overheads can be reduced since ML models are only exchanged and merged by leader nodes as in decentralized federated learning systems.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. Context for an Example Embodiment

The following is a discussion of a context for an example embodiment. This discussion is not intended to limit the scope of the invention, or the applicability of the embodiments, in any way.

Some conventional systems employ patient clustering based on data from medical reports to train a ML model. Such an approach differs from the present solution since conventional patient clustering systems fail to disclose or suggest election of leader nodes, and each ML model used by these conventional systems is inter-community independent (e.g., independent between communities).

In contrast, example embodiments are configured to leverage leader node election for mitigating communication and to consider inter-community relations when training associated ML models. Accordingly, the disclosed application of CD techniques and leader node election in the context of decentralized federated learning has not been leveraged previously.

### A.1. Federated Learning

Federated Learning refers to a collaborative approach conceived around preserving privacy by limiting data exchange towards cloud datacenters. In a conventional FL scenario, all devices train a common ML model using their local datasets. When training is finished, all nodes send their updates to a central node (or server). The server is responsible for aggregating these updates and then broadcasting the new global model to the network's devices (or client nodes). The whole process is referred to as a “FL round.” In its canonical form, sometimes referred to herein as “centralized federated learning,” there is only communication between the server and the nodes, e.g., nodes may not communicate with each other, and privacy is preserved since no local data leaves the devices except for the model updates.

Decentralized federated learning refers to an alternative to FL in which nodes update their models according to their adjacent nodes. DFL tackles some conventional centralized federated learning problems such as (i) network overhead and higher latency according to the number of communication rounds and the size of the transmitted data, especially in cases with a potentially large number of devices and the distance between each device and the central server; (ii) heterogeneity among participants, where different hardware and network capabilities can introduce problems such as stragglers that can slow down training; (iii) bottleneck in exchanging information between the server and every node, which can also be a point of failure in the operation of the entire system, and; (iv) leaking of sensitive information as the server node is a single point of attack. However, even in decentralized approaches, there are concerns with possible bottlenecks in communication as the number of nodes and their degrees (e.g., thereby implying more mutual connections) can be significantly large.

### A.2. Community Detection

Community Detection algorithms generally aim to partition a given network (e.g., graph) into groups of vertices, sometimes referred to herein as “communities” or “clusters,” according to similarity measures. Consequently, CD focuses on identifying modules and their hierarchical organization by only using information encoded in the graph topology. In a resulting set of detected communities, nodes from the same community are densely connected (e.g., exhibiting maximal similarity) while nodes from different communities are less connected (e.g., exhibiting minimal similarity).

Splitting a network into groups allows for classifying vertices based on their structural position in the modules. Depending on the resulting set of communities found on a network, vertices that share many edges with other group nodes may have an important function of control and stability within the group, while nodes at the boundary of a community may play mediation roles and lead exchanges between different communities.

It is appreciated that any CD algorithm can be applied as part of a technical solution to the technical problems discussed in the present disclosure. For example, the CD algorithm can be selected from a group including, but not limited to, the Girvan-Newman algorithm, non-negative matrix factorization methods, and hierarchical clustering methods. Example CD algorithms are discussed in further detail in Jin, Yu, Jiao, et al., “A survey of community detection approaches: From statistical modeling to deep learning,” IEEE Transactions on Knowledge and Data Engineering (2021), and Newman, “Detecting community structure in networks,” The European physical journal B 38, pp. 321-330 (2004), the entire contents of each of which are incorporated by reference herein for all purposes.

### B. Overview of Aspects of an Example Embodiment

The disclosed techniques leverage the topology of a network to split nodes into clusters, where each cluster elects a representative node (e.g., the cluster's most representative node) by using graph-based measurements. Example embodiments work with an existing network of nodes that are communicatively coupled with each other.

Example steps of the present solution include the following. Consider an undirected graph G=(V,E) composed of a set of vertices V and a set of edges E to be the model of a connected network. As used in the context of example embodiments, the terms “vertices” and “nodes” are sometimes used interchangeably in this disclosure, as well as the terms “edges” and “connections.” In example embodiments, the edges of G are determined by the similarity in preferences between two nodes on a large network. That is, connections are a product of nodes' preference of connecting with similar nodes when the network was formed, due to a prior preferential attachment mechanism that can take any form within the scope of the disclosed embodiments.

More particularly, example embodiments encompass, but are not limited to, the following steps:
1. G is a given graph to be partitioned by a CD algorithm into k disjoint subsets of vertices (where k represents a number of resulting communities). In some implementations the value of k can be user-defined. Alternatively, the value of k can be automatically estimated according to the selected CD algorithm.
2. Determine a leader node in each community, where the leader is configured for aggregating the models of its community and communicating to leader nodes from other communities. In some implementations the election of a leader node in each community can be done by using centrality measures (e.g., selecting the leader node to be the node with highest betweenness centrality). Once a leader node is determined, edges between the identified leader node and leader nodes from other communities as well as to nodes of the identified leader node's same community can be leveraged to facilitate communication (e.g., reduce transmission volume in the network). Otherwise, each pair of nodes is configured to communicate indirectly via intermediary nodes as the network is connected. Accordingly, a decision to add edges to G should account for changing the network topology along with a potential budget of edges.
3. Perform FL rounds within each community (e.g., intra-community). For example, the leader node is configured to receive model updates from client nodes of its community to update a global model as in a CFL setting (e.g., ensuring privacy and the like). Once aggregated, the resulting model is then broadcast to all nodes of its community.
4. Perform inter-community model updates by exchanging models between communities. In some implementations these exchanges are exclusively done by the community leader, reducing the overall communication over the nodes of both communities. After the model updates, each leader node is configured to distribute its final aggregated model to its community nodes.

FIG. 1 shows aspects of an example network solution 100, in accordance with illustrative embodiments. In particular, FIG. 1 illustrates the network solution configured to perform federated training using a graph G 102. In example embodiments, the network solution includes a clustering engine 104 and is configured to provide federated training 106.

In one embodiment, a service can implement the present network techniques. As used herein, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

As used in the context of example embodiments, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees), linear regression model(s), logistic regression model(s), support vector machine(s) (SVM), artificial intelligence device(s), or any other type of intelligent computing system. Any amount of training data may be used (and perhaps later refined) to train the machine learning algorithm to dynamically perform the disclosed operations.

In some implementations, the service is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

The sections herein adopt and extend the notation used above. In summary, example embodiments use a CD technique to split a given network G into clusters (e.g., communities). In some embodiments, the network G can be represented by a graph 102. Each formed cluster is represented by a leader node that is chosen, in some implementations, using a graph-based measurement. The leader node's role is to aggregate all received models and to exchange its model with other communities' leaders. The following sections provide further detail on the present approach, with reference to FIG. 1 to illustrate example components at a high level.

### C. Detailed Description of Aspects of an Example Embodiment

### C.1. Clustering Engine

Referring to FIG. 1, example embodiments of the clustering engine 104 are configured to perform initial steps 106, 108 of the present network solution, as described in the sections following.

### C.1.1. Community Detection

In some implementations, the first step 106 includes a clustering engine 104 receiving as input a set of structured data files that represents G 102 for processing by a CD technique 108. It is appreciated that in some implementations a data transformation may be applied, to transform the input data into an expected format for the CD technique, without departing from the scope of the disclosed embodiments. For example in one implementation, network libraries such as NetworkX can be leveraged to build in-memory graphs and perform the disclosed network partitioning into communities (e.g., using a Girvan-Newman algorithm). Further information on NetworkX can be found in Hagberg, Schult, and Swart, “Exploring network structure, dynamics, and function using NetworkX,” Proceedings of the 7th Python in Science Conference (SciPy2008), pp. 11-15 (2008), the entire contents of which are incorporated by reference herein for all purposes. Additional details for CD are disclosed in the sections following.

More particularly, in example embodiments the first step 106 includes using a CD technique to partition G according to a similarity measure. Accordingly, example expected output includes the partition of G into k sets of nodes {c₁, C₂, . . . , Cₖ}, namely, the communities.

In this setting, an adequate value of k representing the number of communities can help reduce drastically the overall level of information exchanged in the whole network, for example once client nodes will only communicate to their leader node. It is appreciated that the problem of determining a recommended value for k (such as an optimal k) depends heavily on the use case, such as the network topology, the CD algorithm, and related considerations. As discussed in section A.2, various CD surveys include algorithms in which k can be automatically estimated based on problem structure (e.g., non-negative matrix factorization methods), and CD algorithms that do not require such a parameter k (e.g., hierarchical clustering methods). Accordingly, as discussed in further detail herein, any suitable CD algorithm may be leveraged for the disclosed techniques, with or without k, without departing from the scope of the disclosed embodiments.

### C.1.2. Leader Node Election

In example embodiments, after finding communities 106 C={c₁, c₂, . . . , cₖ}, the present solution is configured to select a node from each community to be its leader node 108. In some implementations, these leader nodes serve roles including, but not limited to: (1) aggregating the models of nodes of the same community, and; (2) exchanging models with other communities' leader nodes, to perform inter-community aggregation. In one implementation, an algorithm to select a leader node of each community based on graph-based measurement computations includes the following. First, let lᵢ be the leader node of cᵢ and f_{θ} be a function that computes a graph-based measurement in a node. Therefore, an example leader node selection can be performed as follows.

For each cᵢ ∈C do:
1. z←{f_{θ}(v)|v ∈cᵢ|};
2. lᵢ←argmax(z);
3. Insert lᵢ into the set of leader nodes L.

Example embodiments are configured to apply any selective criterion to find the most representative node (line 2). For example, one implementation includes selecting the node with highest betweenness value in the community, with ties resolved by random selection. As used in the context of example embodiments, “betweenness” refers to a centrality measure that relies on the network topology to compute how many shortest paths pass through nodes in the graph. Higher values imply that most of the shortest paths pass through these nodes.

### C.2. Federated Training

In example embodiments, after the definition of L (step 108), the present solution is configured to execute federated training 110, including steps 112, 114. In federated training, each community is generally operable in a centralized FL approach by aggregating all updates from every client node to its leader node (e.g., intra-community FL round; step 112). Then, in some implementations the leader node is configured to send the aggregated model to all client nodes of its community. Finally, the present framework 100 performs the second step 114 of the federated training in which models are exchanged to other communities (e.g., inter-community model exchanges; step 114). Each inter-community exchange done by a leader node corresponds to receiving models from other communities and aggregating the received models to the current node of the leader node. In alternate embodiments, the model exchanging between leader nodes can be applied every n rounds (instead of exchanging models every round) for particular user cases, where n can be user-defined.

In example embodiments, the federated training can utilize two potential regimes to perform model exchanges among communities towards a single global model or multiple local models.
1. Synchronous exchange: in example embodiments, in this regime each leader node is configured to receive k-1 models, one from each community leader, and configured to send its own model to k-1 other communities. Next, each leader aggregates all received models and its own into a single model, which is subsequently distributed to its client nodes. In alternate embodiments, a value lower than k-1 can be utilized, which implies that a community leader will not receive all models and, thus, each community will have a trained local model. Such an embodiment can be especially useful for further mitigation of network usage and to train models that are related with neighborhood information.
2. Asynchronous exchange: in example embodiments, this regime operates as an extension of the previous regime, and includes aggregating models asynchronously. For example, each leader node is not subject to waiting for all models to arrive and to begin the aggregation process, but instead is configured to consider the first p models, where p is a hyperparameter. Consequently, the asynchronous exchange regime can become a more attractive alternative in contexts where decentralized FL training is preferred.

As a result of intra-community exchanges 112 and inter-community exchanges 114 done during the federated training 110, the effects of transmitting data over the network can be significantly reduced since most of this associated burden is concentrated on k nodes (e.g., leader nodes) of the whole network and close-distance communications are leveraged between client nodes and their leader nodes. Advantageously, in some embodiments when G is modified, the present solution is flexible and the clustering engine 104 can be configured to rerun steps 106, 108, as shown in the dotted line arrow connecting the inter-community model exchange 114 with the community detection 106, without adverse effects on the disclosed embodiments.

### D. Example Methods

FIG. 2 shows a flowchart of an example method 200, in accordance with illustrative embodiments. In example embodiments, the method 200 allows for improved issue handling by identifying similar historical issues as references for a given issue.

In some embodiments, the method 200 can be performed by a service that implements the network solution 100.

In example embodiments, the method 200 includes using a community detection algorithm to partition a network of nodes into a plurality of communities (step 210). In some embodiments, the method 200 further includes determining a number of communities k into which the network is to be partitioned. In further embodiments, k can be user-defined. In alternate embodiments, k can be automatically estimated by the CD algorithm. In some aspects, the CD algorithm is selected from a group comprising the Girvan-Newman algorithm, non-negative matrix factorization methods, and hierarchical clustering methods. In some embodiments, the network is represented as an undirected graph G=(V,E), V is a set of vertices representing the nodes, and E is a set of edges representing connections between the nodes. In one implementation, the graph G is an in-memory graph.

In example embodiments, the method 200 includes using graph-based measurements of the network to elect a leader node for each community (step 220). In some aspects, the leader node is elected using a centrality measure to determine a representative node within each community. In one implementation, the representative node is a most representative node within the community. In some embodiments, the centrality measure is betweenness centrality.

In example embodiments, the method 200 includes performing federated learning within and between the communities through the elected leader nodes (step 230). In one implementation, performing federated learning within the communities includes receiving model updates from client nodes within each community, aggregating the received model updates at the leader node of each community, and broadcasting the aggregated model from the leader node to the client nodes within the same community. In some embodiments, the federated learning between the communities is performed exclusively through the leader nodes, thereby reducing overall communication over the nodes of the network. In one embodiment, performing federated learning between the communities includes exchanging aggregated models between the leader nodes of different communities, and updating the aggregated models based on the exchanged models.

In some embodiments, the method 200 operates in a synchronous exchange regime or an asynchronous exchange regime for model exchanges among communities. In one embodiment, in the synchronous exchange regime, each leader node receives models from other leader nodes and aggregates the received models into a single model for distribution to client nodes within its community. In one implementation, in the asynchronous exchange regime, each leader node aggregates models based on a predefined number of received models without waiting for all models from other leader nodes.

In some embodiments, the method 200 operates in a smart farming environment so as to enhance agricultural processes by reducing network usage and enabling effective operation despite geographical dispersion of devices. An example smart farming environment is described in further detail herein.

While the various steps in the example method 200 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 200 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### E. Example Environment

FIG. 3 shows aspects of an example environment 300, in accordance with illustrative embodiments. The illustrated environment can be, for example, a smart farming environment.

Smart farming aims at using advanced technological devices 315 to optimize complex systems and tracking dynamics in agriculture. For example, these devices can be used to build ML-based solutions to effectively deal with plagues and keep plants healthy. In this setting, these devices can be geographically dispersed in the field and, thus, may not be fully connected to each other (e.g., wireless range) but are reachable by intermediate devices (environment 310). As a result, the volume of data transmitted among these devices to train a much-needed ML model can become a bottleneck on an example farm network.

Leveraging CD techniques, the present solution is configured to detect communities 320 (e.g., groups of devices) in this network and have their leader nodes selected 330 for each community as discussed, respectively, in sections C.1.1 and C.2. The environment 320 shows an example of community detection. In the environment 320, the present system clusters the devices 315 into groups, for example according to a similarity measure. The devices can be represented as nodes in a graph, and the edges 325 generally represent communicative coupling between a given pair of nodes. The environment 330 shows an example leader node election. In the illustrated example, the leader nodes 335a, 335b, 335c can be elected based on graph-based measurements, such as betweenness centrality.

The environments 340, 350 illustrate example model exchange during federated training. The environment 340 shows an example round of federated learning within each community 345a, 345b, 345c. For example, in the community 345a the leader node 335a is configured to distribute its aggregated model to the other nodes. Similarly, the leader nodes 335b, 335c are configured to distribute their aggregated models to the nodes in their respective communities 345b, 345c. The environment 350 shows example model exchanges between the communities 345a, 345b, 345c. For example, the leader node 335a is configured to exchange the models 355a, 355b with the leader node 335b. The leader node 335b is configured to exchange the models 355a, 355b, 355c with the leader node 335a. The leader node 335c is configured to exchange the models 355b, 355c with the leader node 335b. Advantageously, in example embodiments the model exchange between communities is performed exclusively through the leader nodes, thereby reducing overall communication over the nodes 315 of the network. As mentioned, in some implementations the model exchange can occur synchronously. In alternate implementations, the model exchange can occur asynchronously. Additional details on the federated training are discussed in section C.2.

Advantageously, the disclosed techniques help to reduce network usage by only transmitting the necessary models 355a, 355b, 355c among the communities 345a, 345b, 345c. Additionally, this decentralized approach allows the present system to continue to operate effectively even when the devices 315 are geographically scattered in a particular area.

### F. Example Processing Platforms

At least portions of the present network system can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present network system. For example, containers can be used to implement respective processing devices providing compute and/or storage services of a cloud-based system. Again, containers may be used in combination with other virtualization infrastructure such as virtual machines implemented using a hypervisor.

Illustrative embodiments of processing platforms will now be described in greater detail with reference to FIG. 4. Although described in the context of the present network system, these platforms may also be used to implement at least portions of other information processing systems in other embodiments.

FIG. 4 shows aspects of a computing device or a computing system in accordance with example embodiments. The computer 400 is shown in the form of a general-purpose computing device. Components of the computer may include, but are not limited to, one or more processors or processing units 402, a memory 404, a network interface 406, and a bus 416 that communicatively couples various system components including the system memory and the network interface to the processor.

The bus 416 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 400 typically includes a variety of computer-readable media. Such media may be any available media that is accessible by the computer system, and such media includes both volatile and non-volatile media, removable and non-removable media.

The memory 404 may include computer system readable media in the form of volatile memory, such as random-access memory (RAM) and/or cache memory. The computer system may further include other removable/non-removable, volatile/non-volatile computer system storage media. By way of example only, the storage system 410 may be provided for reading from and writing to a non-removable, non-volatile magnetic media (not shown and typically called a “hard drive”) in accordance with the present network techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 416 by one or more data media interfaces. As has been depicted and described in connection with FIGS. 1-3, the memory may include at least one computer program product having a set (e.g., at least one) of program modules that are configured to carry out the functions of the embodiments as described herein.

The computer 400 may also include a program/utility, having a set (at least one) of program modules, which may be stored in the memory 404 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 400 may also communicate with one or more external devices 412 such as a keyboard, a pointing device, a display 414, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 408. Still yet, the computer system may communicate with one or more networks such as a local area network (LAN), a general wide area network (WAN), and/or a public network (e.g., the Internet) via the network adapter 406. As depicted, the network adapter communicates with the other components of the computer system via the bus 416. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-4, any component described with regard to a figure, in various embodiments of the invention, may be equivalent to one or more like-named components described with regard to any other figure. For brevity, descriptions of these components has not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
a memory comprising instructions; and
a processor communicatively coupled to the memory and configured to execute the instructions, the instructions comprising:
using a community detection (CD) algorithm to partition a network of nodes into a plurality of communities;
using graph-based measurements of the network to elect a leader node for each community; and
performing federated learning within and between the communities through the elected leader nodes.

2. The system of claim 1, wherein performing federated learning within the communities includes:
receiving model updates from client nodes within each community;
aggregating the received model updates at the leader node of each community; and
broadcasting the aggregated model from the leader node to the client nodes within the same community.

3. The system of claim 1, wherein the federated learning between the communities is performed exclusively through the leader nodes, thereby reducing overall communication over the nodes of the network.

4. The system of claim 1, wherein performing federated learning between the communities includes:
exchanging aggregated models between the leader nodes of different communities; and
updating the aggregated models based on the exchanged models.

5. The system of claim 1, wherein the leader node is elected using a centrality measure to determine a representative node within each community.

6. The system of claim 5, wherein the representative node is a most representative node within the community.

7. The system of claim 5, wherein the centrality measure is betweenness centrality.

8. The system of claim 1, wherein the system is operable in a synchronous exchange regime or an asynchronous exchange regime for model exchanges among communities.

9. The system of claim 8, wherein in the synchronous exchange regime, each leader node receives models from other leader nodes and aggregates the received models into a single model for distribution to client nodes within its community.

10. The system of claim 8, wherein in the asynchronous exchange regime, each leader node aggregates models based on a predefined number of received models without waiting for all models from other leader nodes.

11. The system of claim 1, wherein the instructions further include determining a number of communities k into which the network is to be partitioned, wherein k is user-defined or automatically estimated by the CD algorithm.

12. The system of claim 1, wherein the CD algorithm is selected from a group comprising a Girvan-Newman algorithm, non-negative matrix factorization methods, and hierarchical clustering methods.

13. The system of claim 1, wherein the system is operable in a smart farming environment so as to enhance agricultural processes by reducing network usage and enabling effective operation despite geographical dispersion of devices.

14. The system of claim 1, wherein the network is represented as an undirected graph G=(V,E), V is a set of vertices representing the nodes, and E is a set of edges representing connections between the nodes.

15. The system of claim 14, wherein the graph G is an in-memory graph.

16. A method comprising:
using a community detection (CD) algorithm to partition a network of nodes into a plurality of communities;
using graph-based measurements of the network to elect a leader node for each community; and
performing federated learning within and between the communities through the elected leader nodes.

17. The method of claim 16, wherein performing federated learning within the communities includes:
receiving model updates from client nodes within each community;
aggregating the received model updates at the leader node of each community; and
broadcasting the aggregated model from the leader node to the client nodes within the same community.

18. The method of claim 16, wherein the federated learning between the communities is performed exclusively through the leader nodes, thereby reducing overall communication over the nodes of the network.

19. The method of claim 16, wherein performing federated learning between the communities includes:
exchanging aggregated models between the leader nodes of different communities; and
updating the aggregated models based on the exchanged models.

20. A non-transitory processor-readable storage medium having stored thereon program code of one or more software programs, wherein the program code when executed by at least one processing device causes the at least one processing device to perform the following steps:
using a community detection (CD) algorithm to partition a network of nodes into a plurality of communities;
using graph-based measurements of the network to elect a leader node for each community; and
performing federated learning within and between the communities through the elected leader nodes.
